(19) United States
(12) Patent Application Publication
(10) Pub. No.: US 2002/0132107 A1
(43) Pub. Date: Sep. 19, 2002

(54) Porous polyethylene membrane

(76) Inventors: Jeffrey James O'Brien, Walworth, NY (US); Hans J. Pip, Etterbeek (BE); Rhonda Rogers Agent, Rochester, NY (US)

Correspondence Address: ExxonMobile Chemical Company, P.O. Box 2149, Baytown, TX, 77522, US

(21) Appl. No.: 10/014,700

(22) Filed: Oct. 22, 2001

Related U.S. Application Data
(63) Continuation-in-part of application No. 09/837,673, filed on Apr. 18, 2001.
Application No. 09/837,673 is a continuation of application No. 09/079,806, filed on May 15, 1998, now Pat. No. 5,984,957.

(51) Int. Cl. B32B 5/24; D21H 11/00; D21H 13/00; B32B 3/00; B32B 3/26; B32B 5/22

(52) U.S. Cl. 428/317.9; 428/316.6; 428/311.11; 428/311.51

(57) ABSTRACT

A porous membrane is provided by biaxially stretching a film of high density polyethylene (HDPE), including particles of an incompatible material. This film has a meshed network of HDPE fibers and striations of layers coplanar with the plane of the film. This film is porous in a direction perpendicular to the plane of the film and has a void content of at least 20%. The porous membrane may have one or more nonporous backing layers. The membrane may be used as filter or battery separator.

### CROSS REFERENCE TO RELATED APPLICATIONS

This application is a continuation-in-part of copending U.S. application Ser. No. 09/837,673, filed Apr. 18, 2001, which is a continuation of application Ser. No. 09/079,806, filed May 15, 1998, now abandoned, the entire disclosures of which are expressly incorporated herein by reference.

### BACKGROUND

A porous membrane is provided by biaxially stretching an extruded layer of high density polyethylene (HDPE), including particles of an incompatible material. This film has a meshed network of HDPE fibers and striations of layers coplanar with the plane of the film. This film is porous in a direction perpendicular to the plane of the film and has a void content of at least 20%. The membrane may, optionally, have one or more nonporous backing layers.

There are many possible applications for a product that can absorb water and/or other solvents. Such applications include film structures that need tamper proof bonds, scents or aroma products, labels, wet glue labels, reduced sweating labels, membranes for the growth of bacteria, membranes that do not require a high resistance to membrane compaction, plastic bandage strips, and transdermal patches.

The chemical inertness of many porous polymer materials makes them well suited for forming filtration membranes. These membranes may be used in a variety of applications, such as the filtration of small particles from liquid or gaseous media. For example, such membranes may be used as air filters. Such membranes may also be used as battery separators.

Microporous polymeric membranes may be prepared by thermally-induced phase separation techniques. Such techniques are used to prepare high-density polyethylene membranes, as described in U.S. Pat. No. 4,539,256, polypropylene membranes, as described in U.S. Pat. No. 4,726,989, and ultrahigh molecular weight polyethylene membranes, as described U.S. Pat. No. 4,778,601.

A two layered filter material is described in U.S. Pat. No. 5,283,106. One layer is a fine filter and the other layer is a depth filter, which is 2 to 20 times thicker than the fine filter. Both layers comprise nonwoven fibers or filaments of a synthetic polymer, such as a polyolefin or polyester. A preferred polymer is polyethylene terephthalate.

### SUMMARY

There is provided a film structure comprising, as at least one surface layer, a porous membrane comprising an extruded, biaxially stretched, film of high density polyethylene (HDPE) and particles of an incompatible material, wherein said membrane layer has a meshed network of HDPE fibers and striations of layers coplanar with the plane of the membrane layer, wherein said membrane layer is porous in a direction perpendicular to the plane of the film and wherein said membrane layer has a void content of at least 20%.

### BRIEF DESCRIPTION OF THE DRAWINGS

FIG. 1 is a schematic representation of a cross-section of a medicated pad material having a porous membrane layer.

FIG. 2 is a schematic representation of a cross-section of a film having a surface membrane layer and three backing layers.

FIG. 3 is a schematic representation of a cross-section of a film having a surface membrane layer and two backing layers.

### DETAILED DESCRIPTION

Methods for making films with a surface layer with an open cell pore structure are described in U.S. application Ser. No. 09/079,807, filed May 15,1998. According to this method a cavitating agent is used with a particular polymeric matrix material, which is high density polyethylene (HDPE) or medium density polyethylene (MDPE). When this material is stretched, separations which form voids are formed not only horizontally, i.e. within or parallel to the plane of the film, but also in the vertical dimension or perpendicular to the plane of the film.

As the term high density polyethylene (HDPE) is used herein, it is defined to mean an ethylene-containing polymer having a density of 0.940 or higher. (Density (d) is expressed as g/cm³.) It is noted that the tensile strength of HDPE increases when the density of HDPE increases. One particularly suitable HDPE is the resin sold as M6211 by Equistar. Another particularly suitable HDPE is the resin sold as HDZ128 by Exxon. Other HDPE resins include, for example, BDM 94-25 available from Fina Oil and Chemical Co. Dallas, Tex., and 19C and 19F available from Nova Corporation, Sarnia, Ontario, Canada.

The term “medium density polyethylene” (MDPE) as used herein is defined to mean an ethylene-containing polymer having a density of from about 0.926 to about 0.940. MDPE is readily available, e.g., Dowlex™ 2038 or Dowlex™ 2027A from The Dow Chemical Company.

An incompatible material, also referred to herein as a cavitating agent, is blended with HDPE or MDPE to provide a voided layer. Such agents may be added to the HDPE or MDPE prior to extrusion and are capable of generating voids (cavities) in the structure of the film during the film-making process. It is believed that small inhomogeneities introduced into the HDPE or MDPE layer by the cavitating agent result in points of weakness in the polyethylene sheet. The biaxially orienting step then induces separations in the HDPE or MDPE layer, causing cavitation in the processed film. As mentioned previously, the separations in the core layer vary in size and are formed not only horizontally, i.e., within or parallel to the plane of the film, but also in the vertical dimension or perpendicular to the plane of the film.

Inorganic cavitating agents, especially hydrophilic inorganic cavitating agents, may be used. Hydrophilic cavitating agents are particularly suited for substrates which are intended to be receptive to water. A preferred cavitating agent is calcium carbonate (CaCO₃).

Organic cavitating agents, such as polystyrene and polybutylene terephthalate (PBT), may be used. When used, the organic cavitating agents may be extremely finely divided and resistant to melting at operating temperatures in order to produce the desired degree of inhomogeneity in the polymer sheet. Crosslinked polymeric cavitating agents tend to be particularly melt resistant. Cavitating agents can be included using methods known in the art, such as those described in U.S. Pat. Nos. 4,377,616 and 4,632,869, incorporated herein by reference.

The percentage of cavitating agent included in the HDPE or MDPE layer, based on the entire weight of the layer, may be from 2 wt % to 40 wt %, for example, from 4 wt % to 24 wt %, e.g., from 7 wt % to 18 wt %, especially when CaCO₃ is used.

The blend of HDPE or MDPE and cavitating agent may be passed through a flat sheet extruder die at a temperature ranging from about 230° C. to about 280° C. This layer may be coextruded with one or more backing layers to form a multi-layer film. The extruded layers may be cast onto a cooling drum, quenched and stretched to achieve biaxial orientation.

For example, blends of HDPE and 5 to 10 wt % CaCO₃ may be cast at a temperature between 160-180° F. (71-82° C.) depending upon the thickness of the sheet, i.e. the caster temperature may be higher for thicker sheets. In addition, each film may be stretched in the machine direction at a temperature about 245-250° F. (118-121° C.) and in the transverse direction at about 262° F. (128° C.).

Conventional casting apparatus may be used to prepare the present film. For example, cast extrusion may use a standard multi-roll stack system or a cast roll with an air cap (high velocity air applied to the outside of the sheet). A cast roll and water bath system may be used, although this type of system can affect film clarity, generally yielding a rougher and more opaque film.

Biaxial orientation of the present film tends to evenly distribute strength qualities of a film in the longitudinal or “machine direction” (MD) of the film and in the lateral or “transverse direction” (TD) of the film. Biaxial oriented films tend to be stiffer and stronger, and also exhibit much better resistance to flexing and folding forces.

Biaxial orientation can be conducted simultaneously in both directions, however, it is expensive to employ apparatus having the ability to do this. Therefore, most biaxial orientation processes use apparatus which stretches the films sequentially, first in one direction and then in the other, preferably in the MD first and then in the TD. A discussion of high biaxial orientation of polyethylene films is provided in U.S. Pat. No. 5,885,721. The present films may, for example, be stretched in the MD from about 5:1 to about 8:1 and in the TD from about 6:1 to about 15:1.

The present film may have more than one cavitated layer. For example, such a three layer film may have a cavitated HDPE surface layer, a cavitated HDPE core layer and a noncavitated (i.e. void free) thermoplastic skin or backing layer.

When the cavitated surface layer is coextruded with one or more noncavitated backing layers, the film is more suited to biaxial orientation, especially in the transverse direction (TD). In particular, without the backing layer, the cavitated surface layer is prone to tearing when cavitated portions are secured by clamps, clips or hooks of a tenter frame and then stretched, especially under the conditions and processing rates used in commercial scale operations.

In order to convert a film with an open celled film layer and a non-cavitated backing layer into a completely porous membrane structure, the non-cavitated backing layer may be separated from an open celled film layer by a simple peeling action. Such separation may take place without much resistance. Peeling the backing layer off of the cavitated surface layer may result in a film which is porous form one surface to the other in a direction perpendicular to the film.

Thinner backing layers, e.g., having a thickness of 0.05 mil or less, tend to be easier to peel off the back of a cavitated layer than thicker backing layers, e.g., having a thickness of greater than 0.05 mil.

There is no particular limit to the number of layers. Films with at least 5 layers may be prepared by coextrusion techniques. Films with more than 5 layers may be prepared by laminating together two or more multi layer films.

The backing layer material may be polypropylene, HDPE or another polymer that can be coextruded with the rest of the film structure (i.e. the cavitated porous layers). For example, the backing layer material may be polypropylene homopolymer, EP copolymer, EPB terpolymer, HDPE, LPDE and other polymers.

Backing layer(s) may be made with various barrier polymers, and/or coated with various barrier polymers, to obtain a barrier layer. Examples of such barrier polymers include polyvinylidene chloride (PVDC) and polyvinyl alcohol (PVOH). The barrier layer may, optionally, be metallized or coated with other materials, such as silica.

The film with the barrier layer intact could be installed in the position of a filter or membrane. The film would act as a barrier until the barrier layer is removed, thereby converting the film into a filter or membrane.

For the purposes of illustration, for example, para-dichlorobenzene crystals could be placed in a container (e.g., a glass jar) and sealed with the present film including the barrier layer on top. Para-dichlorobenzene is a volitile solid substance which is toxic to insects and is the active ingredient of “moth balls”. The barrier layer would contain and maintain the freshness of the para-dichlorbenzene crystals until ready for use. At a later date, one could simply peel off the barrier layer and place the jar in a storage close. Para-dichlorobenzene vapors would then pass through the exposed membrane into the storage closet to control insect damage to clothing.

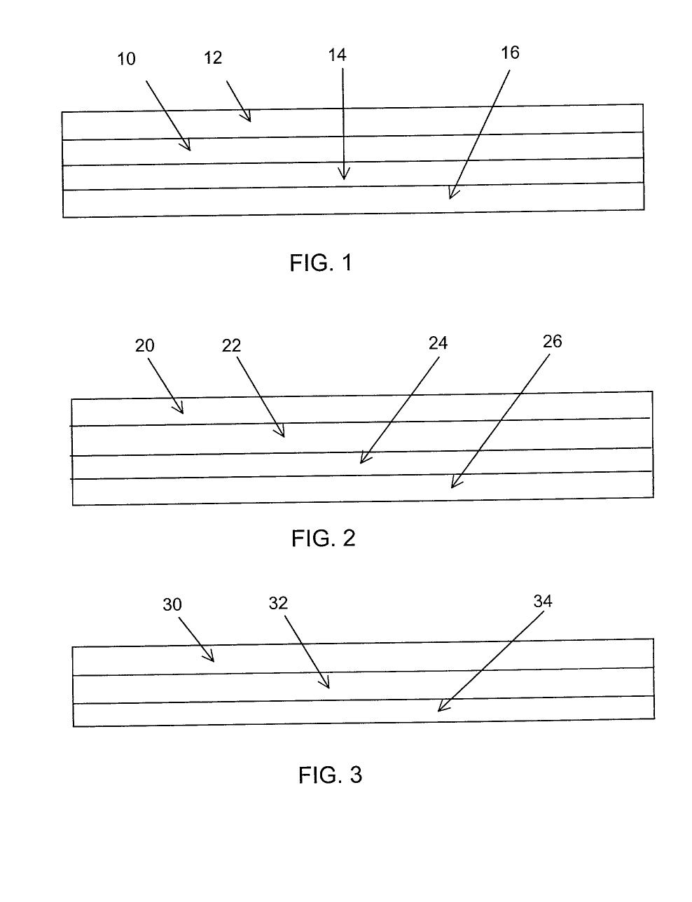

FIG. 1 shows the use of a porous membrane layer 10 in a medicated pad material for a transdermal patch. On one side of the porous membrane layer 10 is a peelable barrier layer 12. On the side of the porous membrane layer 10 is a layer of medicine 14, which may occupy a void space provided on the side of the porous membrane layer 10. Optionally, the medicine may by impregnated in or otherwise be partially or entirely contained within the void space of the porous membrane layer 10. The medicine is contained adjacent to or within the membrane layer 10 by a backing material 16, which may comprise one or more thermoplastic film layers, which prevent passage of the medicine there through. The backing material 16 may be affixed to an adhesive plastic strip (not depicted in FIG. 1), which can adhere to skin for delivery of medicine when the transdermal patch is used.

In particular, just prior to use, the barrier layer 12 may be peeled off the membrane layer 10, and the exposed surface of the membrane layer 12 may be placed against a skin area and held in place by the above-mentioned adhesive plastic strip.

FIG. 2 shows an example of a four layer film with a porous membrane surface layer 20 and three backing layers. Each of these backing layers may be made from any of the backing layer materials described above. For example, layer 22 may be a noncavitated high density polyethylene layer; layer 24 may also be a noncavitated high density polyethylene layer; and layer 26 may be a noncavitated layer of polyethylene or polypropylene.

FIG. 3 shows an example of a three layer film with a porous membrane surface layer 30 and two backing layers. Each of these backing layers may be made from any of the backing layer materials described above. For example, layer 32 may be a cavitated or noncavitated polypropylene layer; and layer 34 may be noncavitated layer of polyethylene or polypropylene.

The multi layer films of FIGS. 2 and 3 may be adapted for use as label materials, wherein the label is adhered to a container, such as a glass or plastic bottle, via a wet glue or solvent based (e.g., water based) adhesive. In particular, the porous membrane side of the label may be adhered to the container via the wet glue or solvent based adhesive. The void space in the membrane layers 20 and 30 promotes drying of the glue or adhesive. This void space may also promote anti sweat properties of the label.

Films with at least one surface porous membrane layer may be treated with agents having medicinal, such as antibacterial or antifungicidal, or other properties, and used to absorb sweat or other bodily exhalations in shoes or other articles of clothing. For example, pore space of the surface membrane layer may be impregnated with a medicinal or antiodor agent and used in a shoe as a foot odor pad.

Each of the cavitated layer(s) and backing layer(s) may optionally include various additives. Such additives include, but are not limited to, anti-blocks, anti-static agents, coefficient of friction (COF) modifiers, processing aids, colorants, clarifiers, and other additives known to those skilled in the art.

The present cavitated HDPE or MDPE layers may each have a lofting value of at least 3, for example, about 5. Lofting value is defined herein as the thickness ratio achieved by dividing the thickness of the layer achieved with the cavitating agent by the thickness of the layer (with the same amount of polymer) achieved in the absence of the cavitating agent.

It will be understood that pores of the membrane can be open like a sponge. In particular, these pores can connect one planar surface of the membrane to the other, such that a fluid (liquid or gas) can pass through the membrane, via the pores, whereas the membrane restricts the passage of solid particulate matter, which is larger than the pore size of the membrane. Such a membrane may have a maze of flow channels in a polymeric matrix and may be useful as a depth filter.

The orientation step used to produce the present cavitated films introduces a certain degree of order the resulting structure. However, the polymeric matrix has many random features. In view of the random matrix structure of the present cavitated HDPE layers, it is difficult to precisely measure the average pore diameter of these layers. However, average pore diameter may be estimated by observation of the film under a scanning type electron microscope. In general terms, these cavitated HDPE or MDPE layers may have an average pore diameter of 0.1 to 10 microns, for example, from 0.1 to 2 microns. In a general sense, the pore size of the layers can be adjusted depending on the extent and rate of orientation; the nature, amount and size of the cavitating agent; and other factors.

One or more coatings may optionally be applied to the porous films to modify the pore space thereof, such as by reducing the effective pore size thereof (e.g., by partially blocking pores or lining the internal pore space with a thin coating layer) or by changing the properties of the pores (e.g., rendering them more hydrophilic or more hydrophobic).

These cavitated HDPE or MDPE layers may have a void content (also referred to herein as porosity) of at least 20%, e.g., 20-85%, preferably at least 50%. Porosity is measured by dividing (T₁−T₂) by T₁ and multiplying this fraction by 100, wherein T₁ is the thickness of the cavitated layer and T₂ is the thickness of the layer in the absence of cavitation. T₂ may be calculated on the basis of the density of the HDPE or MDPE.

As described in U.S. Pat. Nos. 4,861,644 and 5,650,451, the polymeric matrix materials in open celled layers may be composed of ultrahigh molecular weight polyethylene or high molecular weight polyethylene. However, the present polymeric matrix materials in the open celled layers may be composed of polyethylene other than ultrahigh molecular weight polyethylene or high molecular weight polyethylene. Indeed, the present open celled layers may be substantially free of any such ultrahigh molecular weight polyethylene or high molecular weight polyethylene. For the purposes of the present disclosure and the claims which follow, the above-mentioned expression “substantially free” is intended to connote that no such ultrahigh or high molecular weight polyethylene is intentionally added to the polymeric matrix, but these polymers may be present as unintended impurities in very small amounts, e.g., less than one wt % of the total polymer in the polymeric matrix.

The polyethylene used to form the present open celled film layers may have one or more (for example, all) of the following properties: (1) a molecular weight of less than 250,000; (2) an intrinsic viscosity of less than 5 dl/g, for example, less than 4 dl/g or even 3.5 dl/g (e.g., as measured by the method described in U.S. Pat. No. 5,650,451); and (3) an ASTM D 1238-86 condition E melt index of from 0.4 to about 4, e.g., from 0.5 to about 1.5, grams/10 minutes.

For the above-mentioned ASTM value, it will be understood that condition E may also be expressed as ASTM D 1238-190-2 and involves a temperature of 190° C. and a top load of 2 kg.

Unlike the high molecular weight polymers in the cavitated layers described in U.S. Pat. Nos. 4,861,644 and 5,650,451, the present lower molecular weight polymeric matrix materials need not be combined with a plasticizer or processing aid, such as a paraffin wax. Consequently, the present cavitated layers, made from lower molecular weight polymers, do not need to be subjected to an extraction treatment to remove the plasticizer. Furthermore, as pointed out in U.S. Pat. No. 5,650,451 at column 11, lines 59-64, even after an extraction treatment, up to 5 wt % of residual plasticizer can remain in the film. The present cavitated layers, prepared without a plasticizer, are obviously totally free of residual plasticizer.

Polyolefins, such as polyethylene, are inherently hydrophobic. The surfaces of these polymers must be treated to render these surfaces hydrophilic. Such treatments for making the surfaces of non-cavitated polyolefin films more hydrophilic include flame treatment and corona treatment. However, flame treatment and corona treatment tend to generate heat sufficient to melt polymers and damage the present open celled cavitated film surface. Furthermore, flame treatment and corona treatment are not well suited for penetrating the pore structure of open celled cavitated films.

To render an open celled porous film made from a polyolefin water absorbent, it is necessary to treat not only the outer surface of the film but also the inner surfaces of the pores. It has been discovered that certain types of plasma treatments are suited for this purpose. The plasma is a gas with relatively high concentrations of ions, free radicals, and free electrons. Under the right conditions it can penetrate into the pores and react with their interior surfaces.

Plasma treatment may take place under atmospheric conditions, i.e. conditions where a vacuum is not applied during treatment. Such atmospheric plasma treatments are described in U.S. Pat. No. 6,118,218 and in an article by S. A. Pirzada, A. Yializis, W. Decker and R. E. Ellwanger, entitled “Plasma Treatment of Polymer Films”, Society of Vacuum Coaters 42nd Annual Technical Conference Proceedings, Chicago, 1999, pp. 301-306. By means of this atmospheric plasma treatment, it is possible to apply plasma to the cavitated polyolefin surface at a temperature less than the melting point of the polyolefin, e.g., less than 130° C. or even less than 100° C. Equipment for making such plasma treatments at or near atmospheric pressures is available from Sigma Technologies International, Inc., 10960 N. Stallard Place, Tucson, Ariz. An operating frequency of 40 kHz is recommended for plasma treatment of polymer surfaces.

An advantage of the atmospheric plasma treatment is that it can take place under conditions insufficient to generate enough heat to melt polymers or otherwise distort the structure of the film, especially the cavitated portions thereof. By way of contrast, U.S. Pat. No. 5,650,451 states that treatment of a biaxially oriented high molecular weight film at a temperature of 132 to 145° C. for one second to ten minutes can result in a loss of specific surface area of 20 m²/g or more.

In order to assure maximum penetration of plasma into the pores of the treated sheet material, it has been discovered that the operating frequency should be rather high. In particular, the frequency of the plasma generating electrode can be run at 20-40 kHz, but penetration into pore space was found to be increased at higher frequencies, such as greater than 5 MHz, for example, from 5 MHz to 20 MHz.

The plasma treating gas may include one or more of a variety of gases including oxygen, nitrogen, air, carbon dioxide, methane and other inert or reactive gases. For example, an oxygen containing gas, such as O_{2,} CO₂ or air, may be used alone or, optionally, in admixture with an inert gas, such as argon or helium.

The surface of the present memebrane has a breakaway quality, such that when a surface of the membrane is pressed against an adhesive surface, such as an adhesive tape, a thin portion of the membrane surface becomes affixed to the adhesive and peels off of the membrane upon removing the adhesive surface. This quality may be used to expose fresh surfaces of the membrane periodically during the course of a filtration operation. For example, at periodic intervals, filtration could be interupted, an adhesive tape could be pressed against a surface of the membrane including filtered material (e.g., particulate material), and the adhesive tape could then be removed taking with it filtered material and a thin layer of the membrane, thereby exposing a fresh surface of the membrane.

### EXAMPLE 1

This Example describes the preparation of a cavitated HDPE film having an open celled pore structure.

A three layer porous HDPE film was prepared. The film structure included a top porous skin layer A, and porous core layer B, and a bottom skin layer C.

The top porous skin layer A included 90 wt % HDPE (Exxon 7845.30) as the polymer matrix material, 9 wt % CaCO₃ and 1 wt % fluoropolymer as an internal lubricant. The CaCO₃ and fluoropolymer were both added in the form of a masterbatch with the polymer matrix material. More particularly, the top porous skin layer A included 79 wt % HDPE (Exxon 7845.30) as the polymer matrix material, 18 wt % CaCO₃ masterbatch containing 50 wt % CaCO₃, and 1 wt % fluoropolymer as an internal lubricant.

The porous core layer B included 94 wt % HDPE (Exxon 7845.30) as the polymer matrix material, and 6 wt % CaCO₃. The CaCO₃ was both added in the form of a masterbatch with the polymer matrix material. More particularly, the porous core layer B included 88 wt % HDPE (Exxon 7845.30) as the polymer matrix material, and 12 wt % CaCO₃ masterbatch containing 50 wt % CaCO₃.

The bottom skin layer was a medium density polyethylene (MDPE) (Dowlex 2027A) with a minor amount of antiblock additives.

The total polymer gauge (without cavitation) is 1.4 mil. The cavitated film gauge after biaxial orientation was 4.5 mil. The total polymer gauge can be calculated from the polymer weight and density.

The polymer mixtures of the layers were extruded at around 250° C. into a base sheet, which is then stretched 5 times in the machine direction (MD) and 8 times in the transitional direction (TD).

The skin or backing layer C can be removed by a simple peeling action to convert the film into a membrane structure having layers A and B. The backing layer may be removed before or after further treatment of the film, such as by plasma treatment, as described in Examples which follow.

### EXAMPLE 2

The porous surfaces of two film samples (i.e. Sample 1 and Sample 2), prepared according to the procedure of Example 1, were treated with plasma at atmospheric conditions. The plasma gas was 100% oxygen.

Each film sample was treated with plasma generated at two different frequencies, i.e. 40 kHz and 13.5 MHz. Electron Spectroscopy for Chemical Analysis (ESCA) was used to measure the elements present after treatment, in terms of atomic equivalents of total oxygen (O); total carbon (C); carbon singly bound to carbon or hydrogen [C—(C,H)]; hydroxyl and ether groups [C—(O,N)]; carbonyl groups (C═O); and ester and carboxylic acid groups (O—C═O).

Results are summarized in Table 1. In Table 1 all percentages are atom percents.

TABLE I

| Sample | | | | | | | |
|---|---|---|---|---|---|---|---|
| No. | Frequency | O % | C % | C − (C,H) | C − (O,N) | C = O % | O − C = O % |
| 1 | 13.5 MHz | 11.4 | 87.3 | 78 | 5 | 2 | 2 |
| 1 | 40 kHz | 18.2 | 79.4 | 64 | 9 | 4 | 2 |
| 2 | 13.5 MHz | 11.2 | 87.9 | 79 | 4 | 2 | 2 |
| 2 | 40 kHz | 17.3 | 81.6 | 65 | 9 | 4 | 4 |

Table 1 illustrates that in all cases the 40 kHz treatment had a higher level of oxygen and a higher level of oxygen-bonding atoms vs. the 13.5 frequency plasma treatment. Similar results were obtained when a non-porous polypropylene film was treated with 40 kHz and 13.5 MHz plasma.

### EXAMPLE 3

Film samples, prepared according to the procedure of Example 1, were treated with plasma according to the treatment procedures described in Example 2.

These treated samples were tested for water wicking according to the Cahn Wicking test. Total water wicking was greater for the samples treated at 40 kHz, as compared with the samples prepared at 13.5 MHz. For example, as explained in Example 7, hereinafter, when a film sample treated at 40 kHz was tested for water wicking, its weight increased by 253.00 mg. However, when an equivalent sample treated at 13.5 MHz was tested, the weight increased by only 153.09 mg.

As expected, for a given frequency, increased power and increased treatment time resulted in increased water wicking.

### EXAMPLE 4

The wicking tests of Example 3 were repeated, except that dye and pigment based inks were wicked into the samples instead of water. For the most part, the 40 kHz treated film absorbed the most weight of ink. However, the difference in weights was not as great as with water.

### EXAMPLE 5

Film samples, prepared according to the procedure of Example 1, were treated with plasma according to the treatment procedures described in Example 2.

These treated samples were tested for ink drying time with various inks, including a hard to dry low humectant, ink applied by ink jet printing. Ink drying time was less for the samples treated with the 13.5 MHz frequency plasma.

### EXAMPLE 6

Film samples (i.e. Samples 3-6), prepared according to the procedure of Example 1, were treated with plasma according to the treatment procedures described in Example 2.

These treated samples were tested for ink infiltration. In particular, a cut cross section of inkjet printed film was viewed on an optical microscope to compare how far the ink soaked into the film. Infiltration percent was measured by multiplying the depth of ink penetration by 100 and dividing by the total film thickness.

Results are summarized in Table 2. This Table also reports the maximum amount of ink wicking for both dye ink and pigment ink.

TABLE 2

| | | | | Max | |
|---|---|---|---|---|---|
| Sample | Plasma | Max Dye | Dye Ink | Pigment | Pigment Ink |
| No. | Frequency | Wicking | Infiltration | Wicking | Infiltration |
| 3 | 40 kHz | 181.92 | 13.27 % | 156.06 | 39.47 % |
| 3 | 13.5 MHz | 170.10 | 40.00 % | 160.05 | 58.08 % |
| 4 | 40 kHz | 173.10 | 13.19 % | 156.58 | 26.66 % |
| 4 | 13.5 MHz | 164.27 | 22.64 % | 150.23 | 25.48 % |
| 5 | 40 kHz | 199.87 | 11.92 % | 175.44 | 36.49 % |
| 5 | 13.5 MHz | 181.67 | 30.77 % | 160.39 | 34.61 % |
| 6 | 13.5 MHz | 190.04 | 30.28 % | 165.12 | 46.51 % |

The test results summarized in Table 2 demonstrate that the 13.5 MHz frequency treatment allows ink to penetrate deeper into the film, especially when dye inks are used.

### EXAMPLE 7

Samples of the film of Example 1, corona treated or treated with plasma at a frequency of 40 kHz, were tested to measure water absorption into the film by the Cahn Wicking test. This test dips a one inch sample of film into a beaker of water and continuously measures the weight of the sample. The initial weight is set to zero and the weight gain or loss is the amount of water absorbed by the sample. If the sample is hydrophobic and has a density less than water, the sample measurement will be negative because of buoyancy. If the sample hydrophilic and has a density less than water, the sample measurement will start out negative and after some time, as water is absorbed into the sample, end up positive. If the sample is hydrophilic and has a density less than water, the sample measurement could always be positive, if the absorption rate is fast.

In the wicking test, the corona treated sample gave an initial water absorption value of −27.5 mg and a maximum water absorption value of 9.82 mg. These values indicate that the corona treatment failed to make the sample hydrophilic.

In the same wicking test, the plasma treated sample gave an initial water absorption value of 231.72 mg and a maximum water absorption value of 253.00 mg. These values indicate that the plasma treatment made the sample hydrophilic.

### EXAMPLE 8

A sample of the Teslin™ film, available from PPG Industries, Inc., was treated with plasma at a frequency of 40 kHz, and tested to measure water absorption into the film by the Cahn Wicking test. An untreated sample was also tested by this test.

In the wicking test, the untreated Teslin™ sample gave an initial water absorption value of −399.27 mg and a maximum water absorption value of −372.63 mg. These values indicate that the untreated sample was very hydrophobic.

In the same wicking test, the plasma treated Teslin™ sample gave an initial water absorption value of 150.72 mg and a maximum water absorption value of 181.27 mg. These values indicate that the plasma treatment made the sample hydrophilic.

What is claimed is:

1. A film structure comprising, as at least one surface layer, a porous membrane comprising an extruded, biaxially stretched, film of high density polyethylene (HDPE) and particles of an incompatible material, wherein said membrane layer has a meshed network of HDPE fibers and striations of layers coplanar with the plane of the membrane layer, wherein said membrane layer is porous in a direction perpendicular to the plane of the film and wherein said membrane layer has a void content of at least 20%.

2. A film structure according to claim 1, wherein said incompatible material is calcium carbonate.

3. A film structure according to claim 1, wherein said surface membrane layer is treated with plasma at a temperature below the melting point of said HDPE.

4. A film structure according to claim 1, which is completely porous from one surface of the film to the other surface to the film.

5. A film structure according to claim 4 adapted for use as a filter or a battery separator.

6. A film structure according to claim 1, wherein said membrane layer has a void content of 20-85%.

7. A film structure according to claim 6, wherein said membrane layer has a void content of at least 50%.

8. A film structure according to claim 1, wherein said HDPE has the following properties: (1) a molecular weight of less than 250,000; (2) an intrinsic viscosity of less than 5 dl/g; and (3) an ASTM D 1238-86 condition E melt index of from 0.4 to about 4 grams/10 minutes.

9. A film structure according to claim 4 comprising a monolayer of film.

10. A film structure according to claim comprising at least one noncavitated backing layer.
